(19) United States
(12) Patent Application Publication
(10) Pub. No.: US 2014/0216283 A1
(43) Pub. Date: Aug. 7, 2014

(54) METHOD OF FLEXOGRAPHIC PATTERNING USING PHOTOCURABLE COMPOSITION

(71) Applicant: Deepak Shukla, Webster, NY (US)

(72) Inventor: Deepak Shukla, Webster, NY (US)

(21) Appl. No.: 14/244,941

(22) Filed: Apr. 4, 2014

Related U.S. Application Data
(63) Continuation-in-part of application No. 12/945,994, filed on Nov. 15, 2010.

(51) Int. Cl. B41C 1/00

(52) U.S. Cl. CPC B41C 1/00
USPC 101/170

(57) ABSTRACT

Photocured patterns can be provided using relief printing members such as flexographic printing plates. A photocurable composition has at least one N-oxyazinium salt photoinitiator, a photosensitizer for the N-oxyazinium salt, an N-oxyazinium salt efficiency amplifier, and one or more photocurable acrylates. After the photocurable composition is applied using the relief printing member, it is then exposed to suitable radiation to form a photocured pattern on the substrate.

### RELATED APPLICATION

This is a Continuation-in-part of copending and commonly assigned U.S. Ser. No. 12/945,994 (filed Nov. 15, 2010 by Deepak Shukla).

### FIELD OF THE INVENTION

This invention relates to a method of polymerizing acrylates or acrylate-containing compounds such as photocurable resins after printing a photocurable pattern using a relief printing member.

### BACKGROUND OF THE INVENTION

N-oxyazinium salts are known to be photoinitiators for photocrosslinking and photopolymerization as described for example in U.S. Pat. Reissues 27,922 and 27,925 (both Heseltine et al.). Since most N-oxyazinium salt initiators absorb light in UV region of the electromagnetic spectrum, it is common practice to employ a photosensitizer co-initiator to increase their spectral response.

It is generally accepted that photosensitizing co-initiators function by absorption of a photon that results in excitation of an electron from an occupied molecular orbital to a higher energy, unoccupied orbital. The spin of the electron excited to the higher energy orbital corresponds to that which it exhibits in its original orbital or ground state. Thus, the photosensitizer in its initially formed excited state is in a singlet excited state. The lifetime of the singlet excited state is limited, typically less than a few nanoseconds. The excited photosensitizer can return from its singlet excited state directly to its original ground state, dissipating the captured photon energy. Alternatively, the singlet excited state photosensitizer in some instances undergoes intersystem crossing through spin inversion to another excited state, referred to as a triplet state, wherein lifetimes are typically in the microsecond to millisecond range. Since photosensitizer co-initiators that exhibit triplet states have longer lifetimes, the presence of the photosensitizer co-initiators provides a much longer time period for reaction.

GB Publication 2,083,832 (Specht et al.) describes photoinitiator compositions that comprise N-oxyazinium salts and co-initiators based on amino-substituted ketocoumarin triplet photosensitizers. The amino-substituted ketocoumarins exhibit very high intersystem crossing (or triplet state generation) efficiencies ranging well above 10%. U.S. Pat. No. 4,743,528 (Farid et al.) disclose a photoinitiator composition comprising an N-oxyazinium salt, an N-oxyazinium activator, and a photosensitizer having a reduction potential that in relation to the reduction potential of the N-oxyazinium salt activator is at most 0.1 V more positive, and an electron rich amino-substituted benzene. Similarly, U.S. Pat. No. 4,743,530 (Farid et al.) describes photoinitiator compositions containing an N-oxyazinium salt activator and a dye based photosensitizer with maximum absorption above 550 nm and having a reduction potential relative to that of N-oxyazinium salt activator is at most 0.1 V more positive.

N-oxyazinium salts have been demonstrated as useful sources of radicals for photoinitiating polymerization. Single electron transfer from an excited electron donor (D*) to an N-oxyazinium salt results in N—O bond cleavage and the formation of an oxy radical, as shown below in Equation (1):

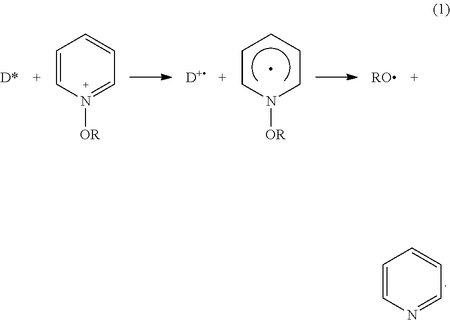

Although a number of dye-based, as well as, triplet ketocoumarin-based photosensitizing co-initiators have been used to initiate photopolymerization using N-oxyazinium salts, most of them have limited curing speed. This is usually due to overall lower quantum efficiency of the process. The quantum yield of a radiation-induced process is the number of times that a defined event occurs per photon absorbed by the system. The event could be the decomposition of a reactant molecule.

In the case of photopolymerization using N-oxyazinium salts and ketocoumarin triplet photosensitizers, the overall quantum efficiency of oxy radical generation is less than or equal to the triplet formation efficiency (the limiting quantum efficiency being defined as state efficiency for reaction times the quantum yield for formation of the reacting state). With dye-based photosensitizers, the overall quantum efficiency is expected to be even lower due to a shorter lifetime of excited dye.

To increase the overall efficiency of a photocuring process, some degree of amplification is necessary. That is, amplification of photoreactions where one photon leads to the transformation of several reactant molecules to products. In some cases, the commercial viability of certain systems can depend on whether a relatively modest amplification, for example, in the 10 to 100 times range, could be achieved. This depends usually upon limitations on exposure time, light intensity, or a combination that can be imposed on a specific use.

In most known amplified photochemical processes, amplification is based on photochemical generation of a species that is subsequently used to catalyze another reaction. Very few examples of amplified photoreactions are known where one photon leads to the transformation of several reactant molecules to products. Most of these quantum-amplified electron-transfer processes involve radical cation reactions, such as valence isomerization, for example, the transformation of hexamethyldewarbenzene to hexamethylbenzene, or the cyclization or cycloreversion between two olefin moieties and a cyclobutane, where quantum yields as high as several hundred have been obtained in polar solvents. In these reactions, the chain is propagated via electron transfer from a reactant molecule (R) to the radical cation of the product (P^{.+}).

Another type of chain-amplified photoreaction involves two reactants where one is oxidized (leading, for example, to dehydrogenation) and the other is reduced. A different kind of chain reaction involving two reactants is that of onium salts. In these reactions, upon one electron reduction an onium salt (Ar—X⁺) undergoes fragmentation to yield an aryl radical, which in turn takes a hydrogen atom from an alcohol to give an α-hydroxyl radical. Chain propagation occurs through electron transfer from the α-hydroxyl radical to another onium salt molecule.

Amplified photosensitized electron transfer reactions of N-methoxypyridinium salts with alcohols of diverse structures were recently demonstrated (Shukla et al., J. Org. Chem. 70, 6809-6819.) to achieve quantum efficiencies of ˜10-20, even at modest reactant concentrations of 0.02-0.04 M, and in spite of the endothermicity of the critical electron transfer step from the intermediate α-hydroxy radical to the pyridinium salt. These reactions can be initiated by a number of singlet or triplet sensitizers, with varying degrees of initiation efficiencies that can be as high as 2.

A number of photoinitiators and photoinitiator compositions have been developed and commercialized to carry out free radical chain polymerization. In most of these methods, free radicals are produced by either of two pathways:

(1) the photoinitiator undergoes excitation by energy absorption with subsequent decomposition into one or more radicals, or

(2) the photoinitiator undergoes excitation and the excited species interacts with a second compound (by either energy transfer or a redox reaction) to form free radicals from the latter or former compound(s).

Most known photoinitiators have only moderate quantum yields (generally less than 0.4), indicating that the conversion of light radiation to radical formation needs to be made more efficient. Thus, there are continuing opportunities for improvements in the use of photoinitiators in free radical polymerization.

In photopolymerization technology, there still exists a need for highly amplified photochemistry, and easy to prepare and easy to use photoinitiator compositions. The need for amplified photoinitiator compositions is particularly acute where absorption of light by the reaction medium may limit the amount of energy available for absorption by the photoinitiators. For example, in the preparation of color filter resists, highly pigmented resists are required for high color quality. With the increase in pigment content, the curing of color resists becomes more difficult. The same is true for the UV-photocurable inks, for example offset printing inks, which also are loaded with pigments. Hence, there is a need for a photoinitiator composition having a higher sensitivity and excellent resolution properties. In addition, there is a need for such photoinitiator compositions to meet the industrial properties such as high solubility, thermal stability, and storage stability.

Besides the challenges above that are often encountered in free radical curing, there is an additional challenge of free radical photocuring inhibition by the presence of oxygen. Oxygen inhibition has always been a problem for photocuring of compositions containing multifunctional acrylate monomers or oligomers using a photoinitiated radical polymerization (for example, see Decker et al., Macromolecules 18 (1985) 1241.). This oxygen inhibition is due to the rapid reaction of carbon centered propagating radicals with oxygen molecules to yield peroxyl radicals. These peroxyl radicals are not as reactive towards carbon-carbon unsaturated double bonds and therefore do not initiate or participate in any photopolymerization reaction. Oxygen inhibition usually leads to premature chain termination resulting in incomplete photocuring. Thus, many photocuring processes must be carried out in inert environments (for example, under nitrogen or argon), making such processes more expensive and difficult to use in industrial and laboratory settings.

Various methods have been proposed to overcome oxygen inhibition of photocuring:

(1) Amines that can undergo a rapid peroxidation reaction can be added to consume the dissolved oxygen. However, the presence of amines in acrylate-containing compositions can cause yellowing in the resulting photocured composition, create undesirable odors, and soften the cured composition because of chain transfer reactions. Moreover, the hydroperoxides thus formed will have a detrimental effect on the weathering resistance of the UV-cured composition.

(2) Dissolved oxygen can be converted into its excited singlet state by means of a red light irradiation in the presence of a dye sensitizer. The resulting ¹O₂ radical will be rapidly scavenged by a 1,3-diphenylisobenzofuran molecule to generate a compound (1,2-dibenzoylbenzene) that can work as a photoinitiator (Decker, Makromol. Chem. 180 (1979), p. 2027). However, the photocured composition can become colored, in spite of the photobleaching of the dye, prohibiting this technique for use in various products.

(3) The photoinitiator concentration can be increased to shorten the UV exposure during which atmospheric oxygen diffuses into the cured composition. This technique can also be used in combination with higher radiation intensities. Oxygen inhibition can further be reduced by using high intensity flashes that generate large concentrations of initiator radicals reacting with oxygen, but hydroperoxides are also formed.

(4) Free radical photopolymerization can be carried out under inert conditions (Wight, J. Polym. Sci.: Polym. Lett. Ed. 16 (1978) 121), which is the most efficient way to overcome oxygen inhibition. Nitrogen is typically continuously used to flush the photopolymerizable composition during UV exposure. On an industrial UV-curing line, which cannot be made completely airtight, nitrogen losses can be significant, thus making the process expensive and inefficient. This is an even greater concern if argon is used to provide an inert environment.

Other less common ways of overcoming oxygen inhibition of acrylate photopolymerization include using a wax barrier and performing UV exposure under water. Each of these techniques has disadvantages that have made them less likely for commercial application.

Contact printing is a flexible, non-lithographic method for forming patterned materials. Contact printing potentially provides a significant advance over conventional photolithographic techniques since contact printing can form relatively high resolution patterns for electronic parts assembly. Microcontact printing can be characterized as a high resolution technique that enables patterns of micrometer dimensions to be imparted onto a substrate surface. Contact printing is a possible replacement to photolithography in the fabrication of microelectronic devices, such as radio frequency tags (RFID), sensors, and memory and back panel displays. The capability of microcontact printing to transfer a self-assembled monolayer (SAM) forming molecular species to a substrate has also found application in patterned electroless deposition of metals. SAM printing is capable of creating high resolution patterns, but is generally limited to forming metal patterns of gold or silver for example using thiol chemistry. Although there are variations, in SAM printing a positive relief pattern provided on an element having a relief image is inked onto a substrate.

Flexography is a one method of printing or pattern formation that is commonly used for high-volume printing runs. It is usually employed for printing on a variety of soft or easily deformed materials including but not limited to, paper, paperboard stock, corrugated board, polymeric films, fabrics, metal foils, glass, glass-coated materials, flexible glass materials, and laminates of multiple materials. Coarse surfaces and stretchable polymeric films are economically printed using flexography.

Flexographic printing members are sometimes known as “relief” printing members (for example, relief-containing printing plates, printing sleeves, or printing cylinders) and are provided with raised relief images onto which ink is applied for application to a printable material. While the raised relief images are inked, the relief “floor” should remain free of ink. These flexographic printing precursors are generally supplied with one or more imageable layers that can be disposed over a backing layer or substrate. Flexographic printing also can be carried out using a flexographic printing cylinder or seamless sleeve having the desired relief image.

While there are numerous methods described in the art to form patterns using relief images, there remains a need to find a way to consistently provide patterns with high resolution lines (for example, 10 μm or less) and feature uniformity using various printable material compositions (or what are sometimes known as “inks”). The industry has been pursuing these goals for many years with limited success and continued research is being done to achieve these goals using a wide variety of print materials. A number of problems must been addressed to achieve the desired high resolution lines.

Transfer of electrically conductive “inks” using the noted flexographic printing process relies upon a good release of the conductive ink from the elastomeric relief element in contact with a receiver element, good affinity of the conductive ink for the receiver element, and the compositional cohesiveness of the conductive ink. There are continued efforts to provide efficient or complete transfer of such “inks” while maintaining or improving conductivity of the conductive materials within the transferred ink.

Thus, there is a need to provide highly efficient photocuring or photopolymerization of acrylate-containing compositions using N-oxyazinium salts in predetermined patterns without the need for inert environment or use of other known methods for reducing oxygen inhibition of free radical formation and reaction.

### SUMMARY OF THE INVENTION

This invention provides method for providing a photocured pattern, comprising:

applying a photocurable composition to a substrate in a patternwise fashion using a relief printing member to form a pattern of the photocurable composition,

exposing the pattern of the photocurable composition to photocuring radiation to form a photocured pattern on the substrate,

wherein the photocurable composition comprising an N-oxyazinium salt photoinitiator, a photosensitizer for the N-oxyazinium salt, an N-oxyazinium salt efficiency amplifier, and one or more photocurable acrylates.

The present invention solves some of difficulties and problems described above by the discovery of the use of a more efficient photoinitiator composition for utilizing radiation in photocuring operations after forming a printed pattern. The photoinitiator composition used in the method of the present invention provides high sensitivity and storage stability that is useful in the photopolymerization technology. Accordingly, the photoinitiator composition that can generate a reactive species by using in combination, an N-oxyazinium salt photoinitiator, a photosensitizer for the N-oxyazinium salt, and an N-oxyazinium salt efficiency amplifier, which is many embodiments, is an organic phosphite that is also referred to as a quantum yield amplifier.

One of the advantages of the present invention is that, when combined with a polymerizable material such as an acrylate, the photoinitiator composition causes rapid curing times in comparison to the curing times known in the prior art. For example, surprisingly, the photoinitiator composition used in this invention performs unexpectedly better (higher quantum efficiency) than known N-oxyazinium salt-containing photoinitiator compositions. This advantage is achieved particularly by using the N-oxyazinium salt efficiency amplifier that was not previously known to accomplish this purpose. This accomplishes photocuring with an efficient use of the radiation because many reactive species are generated per photon absorbed (that is, amplification) occurs. A relatively large amount of material can be photocured with reduced exposure to radiation.

Yet another important advantage of the present invention is that the photoinitiator composition can be used for photocuring in oxygen-containing environments. Because of the high efficiency of the photoinitiator composition, the presence of oxygen, or oxygen inhibition, is not a serious detriment during photocuring.

Because the photocuring speeds are high using the present invention, the photoinitiator composition can be used to advantage with photocurable compositions that are pigmented or with compositions into which light penetration is limited. It is also possible to use the invention for partial curing of photosensitive compositions for example to modify their viscosities.

### BRIEF DESCRIPTION OF THE DRAWING

FIG. 1 is an image of the printed and photocured pattern obtained according to the present invention in Example 7 below.

### DETAILED DESCRIPTION OF THE INVENTION

The following discussion is directed to various embodiments of the present invention and while some embodiments can be particularly desirable for specific uses, the disclosed embodiments should not be interpreted or otherwise considered to be limited the scope of the present invention, as claimed below. In addition, one skilled in the art will understand that the following disclosure has broader application than is explicitly described and the discussion of any embodiment is not intended to limit the scope of the present invention to any described embodiment.

### DEFINITIONS

Unless otherwise indicated, the term “photoinitiator composition” used in this application will refer to embodiments used in the practice of the present invention.

The term “polymerization” is used herein to mean the combining for example, by covalent bonding, of large number of smaller molecules, such as monomers, to form very large molecules, that is, macromolecules or polymers. The monomers may be combined to form only linear macromolecules or they may be combined to form three-dimensional macromolecule, commonly referred to as crosslinked polymers.

As used herein, the terms “curing” and “photocuring” mean the polymerization of functional oligomers and monomers, or even polymers, into a crosslinked polymer network. Curing is the polymerization of unsaturated monomers or oligomers in the presence of crosslinking agents.

The terms “unsaturated monomer,” “functional oligomer,” and “crosslinking agent” are used herein with their usual meanings and are well understood by those having ordinary skill in the art.

The singular form of each component of the photoinitiator composition is intended also to include the plural that is, one or more of the respective components.

The term “unsaturated polymerizable material” is meant to include any unsaturated material having one or more carbon-to-carbon double bonds (ethylenically unsaturated groups) capable of undergoing polymerization. The term encompasses unsaturated monomers, oligomers, and crosslinking agents. The singular form of the term is intended to include the plural. Oligomeric and multifunctional acrylates are examples of unsaturated polymerizable materials.

The term “quantum yield” is used herein to indicate the efficiency of a photochemical process. More particularly, quantum yield is a measure of the probability that a particular molecule will absorb a quantum of light during its interaction with a photon. The term expresses the number of photochemical events per photon absorbed. Thus, quantum yields can vary from zero (no absorption) to a very large number (for example, 10³). In this context, the quantum efficiency of an N-oxyazinium salt photoinitiator is defined as in the following equation:

$$Φ = Quantum Efficiency = \frac{\# reactant alkoxyl radicals generated}{\# photons absorbed}$$

The term “photosensitizer” is meant to refer to a light absorbing compound used to induce photocuring. Upon photoexcitation, the photosensitizer leads to one-electron reduction of the N-oxyazinium salt photoinitiator.

The terms “activator” and “photoinitiator” refer to an N-oxyazinium compound that accepts an electron from an excited sensitizer, a process that leads to fragmentation of the activator to give an oxy radical that initiates polymerization.

The terms “quantum yield amplifier” and “efficiency amplifier” refer to a compound that increases the quantum efficiency of the overall photocuring or photopolymerization process.

The terms “photocurable” and “curable” refer to a material that will polymerize when irradiated for example with radiation such as ultraviolet (UV), visible, or infrared radiation in the presence of the photoinitiator composition. “Actinic radiation” is any electromagnetic radiation that is capable of producing photochemical action and can have a wavelength of at least 150 nm and up to and including 1250 nm, and typically at least 300 nm and up to and including 750 nm.

The term “flexographic printing precursor” refers to some embodiments of elastomeric relief elements useful in the practice of this invention. The flexographic printing precursors include flexographic printing plate precursors, flexographic printing sleeve precursors, and flexographic printing cylinder precursors, all of which can be suitably imaged to provide a relief image to have an average relief image depth of at least 50 μm and up to and including 1000 μm, or at least 100 μm and up to and including 600 μm, relative to the uppermost relief surface. Any desired minimum and maximum relief image depths can be achieved based on a given elastomeric relief element and the printed pattern that is desired. Such elastomeric relief elements can also be known as “flexographic printing plate blanks”, “flexographic printing cylinder blanks”, or “flexographic sleeve blanks”. The elastomeric relief elements can also have seamless or continuous forms.

Flexographic printing precursors can be used to provide relief printing members comprising a relief image that can be used in the present invention.

### Uses of the Photoinitiator Compositions

The photoinitiator composition can be used to cause photocuring or polymerization of various photocurable compounds used for coatings, printable inks, paints, photoresists, or any photocurable imaging compositions that can be used to form photocured patterns using relief printing members.

The present invention can be used to apply and cure a photocurable composition comprised of an organic component containing polymerizable materials that are capable of crosslinking such as acrylate-containing compounds, an N-oxyazinium salt photoinitiator (or activator), a photosensitizer for the N-oxyazinium salt photoinitiator, which photosensitizer has a reduction potential that in relation to the reduction potential of the N-oxyazinium salt photoinitiator, is at most 0.1 volt more positive, and an N-oxyazinium salt efficiency amplifier. Each of the components of the photoinitiator composition is described below and each of these components can be obtained from various commercial chemical suppliers. The photoinitiator composition is generally provided in liquid form at a suitable viscosity for printing using a relief printing member (described below).

### Photoinitiator Compositions

The N-oxyazinium salt photoinitiators used in this invention are N-oxy-N-heterocyclic compounds having a heterocyclic nucleus, such as a pyridinium, diazinium, or triazinium nucleus. The N-oxyazinium salt can include one or more aromatic rings, typically carbocyclic aromatic rings, fused with the N-oxy-N-heterocyclic compound, including quinolinium, isoquinolinium, benzodiazinium, phenanthridium, and naphthodiazinium. Any convenient charge balancing counter-ion can be employed to complete the N-oxyazinium salt photoinitiators, such as halide, fluoroborate, hexafluorophosphate, and toluene sulfonate. The oxy group (—O—R₁) of the N-oxyazinium compound that quaternizes the ring nitrogen atom of the azinium nucleus, can be selected from among a variety of synthetically convenient oxy groups. The N-oxyazinium salt photoinitiators can also be oligomeric or polymeric compounds.

The N-oxyazinium salt photoinitiator can have a reduction potential less negative than −1.4 V and comprise an N-oxy group that is capable of releasing an oxy radical when irradiated of the photocurable composition.

Representative N-oxyazinium salts are represented by the following Structure (I):

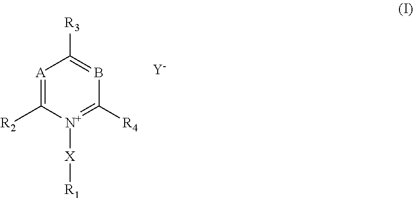

wherein A and B in Structure (I) independently represent a carbon, C—R₅, C—R₆, or nitrogen. X is oxygen (O).

R₁, R₂, R₃, R₄, R₅, and R₆ are independently hydrogen, or substituted or unsubstituted alkyl groups having 1 to 12 carbon atoms or aryl groups having 6 or 10 carbon atoms in the carbocyclic ring, which groups can be substituted with one or more acyloxy, alkoxy, aryloxy, alkylthio, arylthio, alkylsulfonyl, thiocyano, cyano, halogen, alkoxycarbonyl, aryloxycarbonyl, acetal, aroyl, alkylaminocarbonyl, arylaminocarbonyl, alkylaminocarbonyloxy, arylaminocarbonyloxy, acylamino, amino, alkylamino, arylamino, carboxy, sulfo, trihalomethyl, alkyl, aryl, heteroaryl, alkylureido, arylureido, succinimido, phthalimido groups, —CO—R₇ wherein R₇ is a substituted or unsubstituted alkyl or a substituted or unsubstituted aryl group, or —(CH═CH)ₘ—R₈ wherein R₈ is a substituted or unsubstituted aryl group or a substituted or unsubstituted heterocyclic group.

Any of the A, B, and R groups where chemically feasible can be joined to form a ring. Y is a suitable charge balancing anion that can be a separate charged moiety or a charged part of an A, B, or R group.

Other useful N-oxyazinium salts are represented by the following Structure (II):

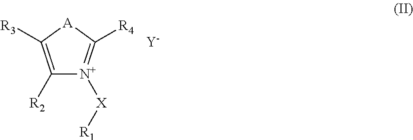

wherein A in Structure (II) represents carbon, C—R₅, nitrogen, sulfur, or oxygen with sufficient bonds and substituents to form a heteroaromatic ring. X is oxygen (O). R₁, R₂, R₃, R₄, and R₅ are independently hydrogen, or substituted or unsubstituted alkyl or aryl groups as described above for Structure (I), or any two R groups may form a ring. Y is a charge balancing anion that can be a separate charged moiety or part of a charged R group.

In some embodiments of Structures (I) and (II), R₁ is a substituted or unsubstituted alkyl group having 1 to 18 carbon atoms or a substituted or unsubstituted aryl group having 6 or 10 carbon atoms in the aromatic ring.

Other useful N-oxyazinium salt photoinitiators having a cation can be represented by the following formulae:

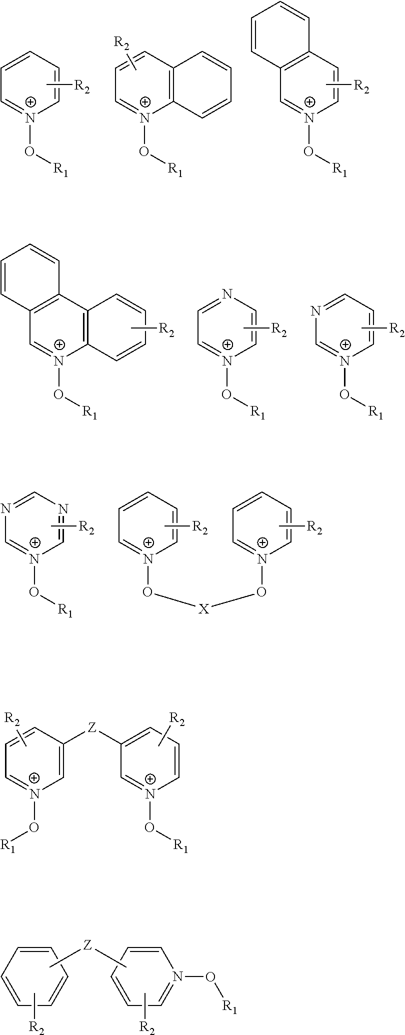

wherein R₁ represents a substituted or unsubstituted alkyl group, substituted or unsubstituted aryl group, or an acyl group, as described above, and wherein R₁ can also include a charge balancing anion, the R₂ groups independently represent hydrogen, or substituted or unsubstituted alkyl, aryl, or heteroaryl groups. Z is a substituted or unsubstituted aliphatic linking group having 1 to 12 atoms in the linking chain.

Other useful N-oxyazinium salt photoinitiators are illustrated by Structures III and IV and the compounds shown in TABLES 1 and 2 of U.S. Pat. No. 7,632,879 (Majumdar et al.) that is incorporated herein by reference for this teaching.

Particularly useful N-oxyazinium salt photoinitiators are compounds OZ-1 to OZ-16 identified below in TABLE I.

TABLE I

| | |
|---|---|
| OZ-1 | 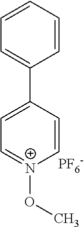 |
| OZ-2 | 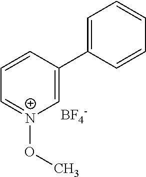 |
| OZ-3 | 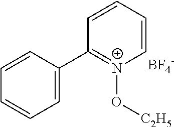 |
| OZ-4 | 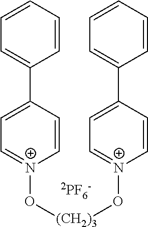 |
| OZ-5 | 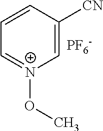 |
| OZ-6 | 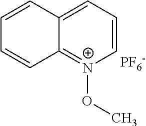 |
| OZ-7 | 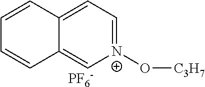 |
| OZ-8 | 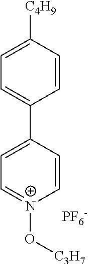 |
| OZ-9 | 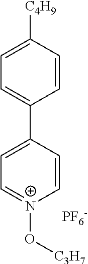 |
| OZ-10 | 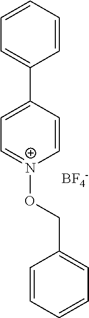 |
| OZ-11 | 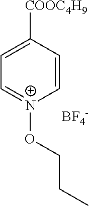 |
| OZ-12 | 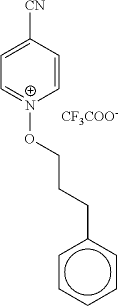 |
| OZ-13 | 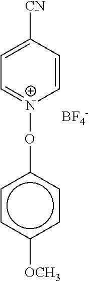 |
| OZ-14 | 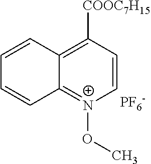 |
| OZ-15 | 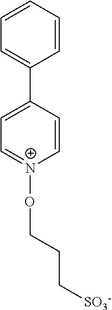 |
| OZ-16 | 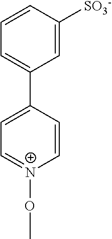 |

Mixtures of N-oxyazinium salt photoinitiators can be used if desired, and the total amount of N-oxyazinium salt photoinitiators in the photoinitiator composition is generally at least 10 weight %, or typically at least 40 and up to and including 80 weight % based on the total weight of N-oxyazinium salt photoinitiator, photosensitizer for the N-oxyazinium salt photoinitiator, and N-oxyazinium salt efficiency amplifier.

The photosensitizer (S) for the N-oxyazinium salt photoinitiator initiates the reaction of the N-oxyazinium salt photoinitiator following absorption of suitable radiation having a λₘₐₓ of at least 150 and up to and including 1250 nm. The photosensitizer generally has a triplet energy of at least 20 kcal/mole of N-oxyazinium salt photoinitiator. As long as the reduction potential of the photosensitizer is more negative than that of the N-oxyazinium salt photoinitiator (that is, it is harder to reduce), the photoinduced electron transfer reaction will be exothermic. The photoinitiated process produces the reactive oxy radical by electron transfer from the excited state of the photosensitizer (*S) to the N-oxyazinium salt photoinitiator. The oxy radical can subsequently react with the N-oxyazinium salt efficiency amplifier, such as a trialkylphosphite, producing a suitable radical such as a phosphoranyl radical that can in turn transfer an electron to the N-oxyazinium salt photoinitiator to continue the chain process. Mixtures of photosensitizers can be used if desired and the photosensitizers in the mixture can absorb at the same or different wavelengths.

Thus, the photosensitizer is capable of transferring an electron from its own lowest excited state after it has absorbed radiation. The driving force for this process depends upon: (a) the excitation energy of the sensitizer, (E^{excit})s, (b) its oxidation potential, (E^{ox})s, (c) the reduction potential of the N-oxyazinium salt photoinitiator, (E^{red})_{N-oxy}, and (d) an energy increment A that varies from near zero in polar solvents such as acetonitrile to about 0.3 eV in nonpolar media. Thus, for the photoinduced electron transfer to be exothermic (that is, for the energy stored in the excited state to exceed the energy stored in the electron transfer products) the relationships shown in the following Equation 7 should be satisfied:

(E_{excit})s>(E^{ox})s−(E^{red})_{N-oxy}+Δ (7)

The excitation energy of the sensitizer, (E^{excit})s, could be that of the singlet or the triplet state depending on which of these states react with the N-oxyazinium salt photoinitiator.

The amount of photosensitizer used in the photoinitiator composition depends largely on its optical density at the wavelength(s) of radiation used to initiate the photoinduced electron transfer to an N-oxyazinium salt. Solubility of the photosensitizer in a photocurable composition can also be a factor. It is possible that the photosensitizer is a covalently bound part of a polymerizable material such as an acrylate. Either a photosensitizer bound in this manner or a non-bound photosensitizer with a low extinction coefficient can be utilized at relatively high levels to help facilitate the transfer of an electron to an N-oxyazinium salt from triplet sensitizer (³S). When covalently attached to a polymeric material, the photosensitizer can comprise at least 0.01 and up to and including 10% based on the total weight of the N-oxyazinium salt photoinitiator. An example of such a covalently bound photosensitizer is a naphthalene moiety (that absorbs actinic radiation) that is bound to polymerizable or photocurable material, or it can be attached to an inert polymeric binder. The amount of the photosensitizers is generally governed by their molar absorptivity or extinction coefficient. Photosensitizers that are not bound to curable compounds or polymers can be present in an amount of at least 1 and up to and including 10 weight %, based on the total weight of N-oxyazinium salt photoinitiator, photosensitizer for the N-oxyazinium salt photoinitiator, and N-oxyazinium salt efficiency amplifier.

The triplet energies of the photosensitizers used in this invention can be obtained in a variety of ways. Energies for some photosensitizers or closely related analogs are disclosed in the literature. For most photosensitizers, the lowest triplet state energies can be obtained from low temperature (for example, 77° K) phosphorescence spectra. The photosensitizer is typically dissolved in a solvent (such as ethyl acetate) or a mixture of solvents and the solution is placed in an optical cell and immersed in liquid nitrogen. The photosensitizer is then excited with radiation at a wavelength where it absorbs, and its phosphorescence spectrum is measured. The highest energy absorption band (the so-called 0-0 band) in the phosphorescence spectrum can usually be taken as the energy of the lowest triplet state of the photosensitizer. For photosensitizers with weak or obscured emission or in which the ground state and lowest triplet state have substantial differences in geometry, triplet energies can be obtained either from rates of energy transfer from a series of molecules with known triplet energies or from measured equilibria with triplets of known energies. The former procedure is described in J. Amer. Chem. Soc. 102, 2152 (1980) and the latter procedure is described in J. Phys. Chem. 78, 196 (1974). In polymer matrices, photosensitizers and other compounds can occupy sites of different polarity, such that exact triplet energies are site dependent. To the extent that this is true for the photosensitizers and co-sensitizers (see below) used in this invention, the reported triplet energies represent approximate or average values.

Especially useful photosensitizers absorb visible light or near ultraviolet light, for example at a wavelength of at least 300 and up to and including 750 nm. The ketocoumarins disclosed in Tetrahedron 38, 1203 (1982) represent one class of useful photosensitizers. The ketocoumarins described in U.K. Patent Publication 2,083,832 (Specht et al.) are also useful photosensitizers. The ketocoumarins exhibit triplet state generation efficiencies.

Other classes of useful photosensitizers include but are not limited to, xanthones, thioxanthones, arylketones, and polycyclic aromatic hydrocarbons.

Examples of specific useful triplet photosensitizers include but are not limited to, compounds S-1 through S-10 shown below in TABLE II. The illustrated photosensitizers can optionally contain substituents as methyl, ethyl, phenyl, aryl, methoxy, and chloro groups to modify various properties such as solubility, absorption spectrum, and reduction potential.

TABLE II

| | |
|---|---|
| S-1 | 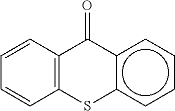 |
| S-2 | 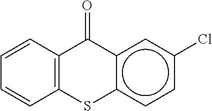 |
| S-3 | 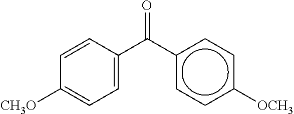 |
| S-4 | 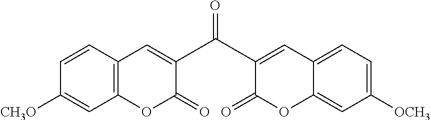 |
| S-5 | 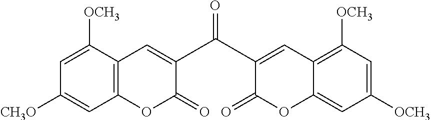 |
| S-6 | 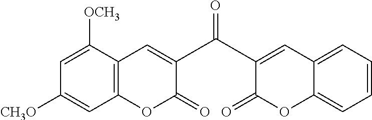 |
| S-7 | 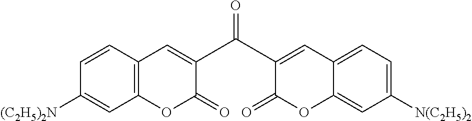 |
| S-8 | 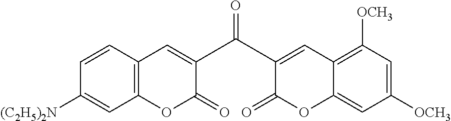 |
| S-9 | 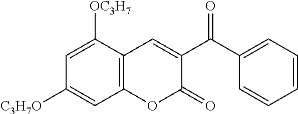 |
| S-10 | 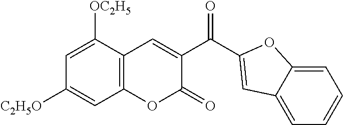 |

In some embodiments of this invention, the photosensitizer can be a dye, which is any dye that by reaction with an N-oxyazinium salt photoinitiator leads to the formation of an oxy radical, which initiates polymerization. The useful classes of photosensitizer dyes can be for example, cyanine dyes, complex cyanine dyes, merocyanine dyes, complex merocyanine dyes, homopolar cyanine dyes, styryl dyes, oxonol dyes, hemioxonol dyes, hemicyanine dyes, squarilium dyes, coumarin dyes, rhodamine dyes, acridine dyes, and oxanol dyes. Representative photosensitizer dyes are described for example in Research Disclosure, Item 36544, September 1996, the disclosure of which is incorporated herein by reference. Some other useful photosensitizer dyes are described in U.S. Pat. No. 4,743,530 (noted above) the disclosure of which is incorporated herein by reference. In general, any dye having a reduction potential that is at most 0.1 V more positive than the reduction potential of an N-oxyazinium salt photoinitiator can be effectively used as a photosensitizes.

Particularly useful photosensitizing cyanine or merocyanine dyes are shown by the general formulae D-1 to D-7 below in TABLE III.

TABLE III

| | |
|---|---|
| D-1 | 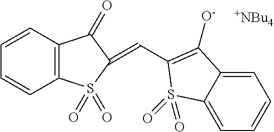 [SMILES: O=C1/C(=C/C2=C([O-])c3ccccc3S2(=O)=O)S(=O)(=O)c2ccccc21 ; "+NBu4"] |
| D-2 | 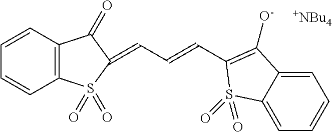 [SMILES: O=C1/C(=C/C=C/C2=C([O-])c3ccccc3S2(=O)=O)S(=O)(=O)c2ccccc21 ; "+NBu4"] |
| D-3 | 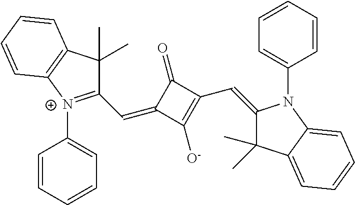 [SMILES: CC1(C)C(/C=C2\C(=O)C(/C=C3/N(c4ccccc4)c4ccccc4C3(C)C)=C2[O-])=[N+](c2ccccc2)c2ccccc21] |
| D-4 | 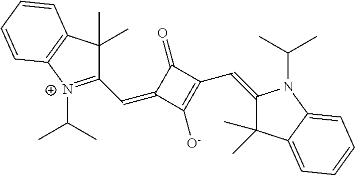 [SMILES: CC(C)N1/C(=C/C2=C([O-])C(=C/C3=[N+](C(C)C)c4ccccc4C3(C)C)/C2=O)C(C)(C)c2ccccc21] |
| D-5 | 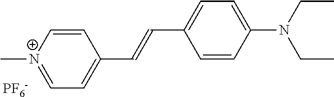 |
| D-6 | 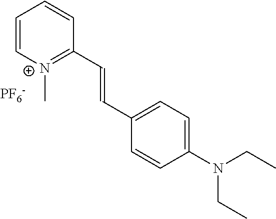 |
| D-7 | 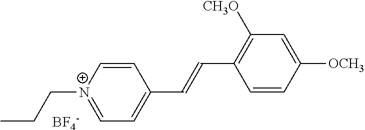 |

The photoinitiator composition used in this invention includes one or more N-oxyazinium salt efficiency amplifiers. In most embodiments, these efficiency amplifiers are phosphites such as organic phosphites.

In general, the phosphite can be represented by the formula:

(R′O)₃P

wherein the multiple R′ groups are the same or different substituted or unsubstituted alkyl groups or substituted or unsubstituted HO[{CH(R)}ₓO]_{y} groups wherein the multiple R groups are the same or different hydrogen atoms or substituted or unsubstituted alkyl groups, or two R′ groups can form a substituted or unsubstituted cyclic aliphatic ring or fused ring system, x is a number at least 2 and up to and including 20, and y is at least 1 and up to and including 20.

The photoinitiator composition can comprise one or more of trimethyl phosphite, triethyl phosphite, tripropyl phosphite, tributyl phosphite, triisobutyl phosphite, triamyl phosphite, trihexyl phosphite, trinonyl phosphite, tri-(ethylene glycol) phosphite, tri-(propylene glycol) phosphite, tri(isopropylene glycol) phosphite, tri-(butylene glycol) phosphite, tri-(isobutylene glycol) phosphite, tri-(pentylene glycol) phosphite, tri-(hexylene glycol) phosphite, tri-(nonylene glycol) phosphite, tri-(diethylene glycol) phosphite, tri-(triethylene glycol) phosphite, tri-(polyethylene glycol) phosphite, tri-(polypropylene glycol) phosphite, and tri-(polybutylene glycol) phosphite as N-oxyazinium salt efficiency amplifiers.

The N-oxyazinium salt efficiency amplifier, especially when it is a phosphite, is present at a molar ratio to the N-oxyazinium salt photoinitiator of at least 0.001:1 and up to and including 10:1, or typically of at least 1:1 and up to and including 5:1.

### Photocurable Compositions

The photoinitiator compositions can be used to prepare photocurable compositions by simply mixing, under “safe light” conditions, the photoinitiator composition, or individually, the N-oxyazinium salt photoinitiator, a photosensitizer for the N-oxyazinium salt photoinitiator, and an N-oxyazinium salt efficiency amplifier, with a suitable photocurable acrylate or other photocurable compound. This mixing can occur in suitable inert solvents if desired. Examples of suitable solvents include but are not limited to, acetone, methylene chloride, and any solvent that does not react appreciably with the phosphite, N-oxyazinium salt photoinitiator, or photosensitizer.

A liquid organic material to be polymerized or photocured (such as an acrylate) can be used as the solvent for mixing, or it can be used in combination with another liquid. An inert solvent can be used also to aid in obtaining a solution of the materials and to provide suitable viscosity to the photocurable compositions for printed patterns. However, solvent-free photocurable compositions also can be prepared by simply dissolving the N-oxyazinium salt photoinitiator, the efficiency amplifier, and photosensitizer in an organic photocurable material with or without mild heating.

Photocurable acrylates can be monomers, oligomers, or polymers containing one or more acrylate groups in the molecule. Such compounds include but are not limited to, various compounds having one or more ethylenically unsaturated polymerizable groups.

In some embodiments, the photocurable acrylate also includes the photosensitizer for the N-oxyazinium salt photoinitiator in the same molecule. For example, such photosensitizers can be ketocoumarin moieties that are parts of molecules that also include acrylate groups.

In other embodiments, the photocurable resins have a weight average molecular weight of at least 100,000.

In the photocurable compositions, a photosensitizer can be present in an amount of at least 5×10⁻⁷ and up to and including 1×10⁻⁴, or at least 10⁻⁶ and up to and including 5×10⁻⁵, or more typically at least 2×10⁻¹⁵ and up to and including 2×10⁻⁴, moles per gram of photocurable acrylate.

N-oxyazinium salt photoinitiator concentrations in the photocurable composition can be specified in terms of moles of N-oxyazinium salt photoinitiator per gram of photocurable acrylate. Typical concentrations of N-oxyazinium salt photoinitiator are at least 6×10⁻⁷ and up to and including 6×10⁻², or typically at least 6×10⁻⁶ and up to and including 6×10⁻², or more typically at least 6×10⁻⁴ and up and including 60×10⁻² moles per gram of photocurable acrylate.

In addition, the efficiency amplifier, such as a phosphite, can be present in the photocurable composition in an amount of at least 5×10⁻⁷ and up to and including 1×10⁻², typically at least 10⁻⁶ and up to and including 5×10⁻², or more typically at least 10⁻⁴ and up to and including 5×10⁻² moles per gram of N-oxyazinium salt photoinitiator. The use of larger amounts of efficiency amplifier phosphite is possible.

It can also be useful to include one or more film-forming non-photocurable resins in the photocurable composition to provide viscosity control and printability of patterns. Such components can be present in the photocurable compositions in any suitable amount for the desired purpose, for example at least 0.5 weight % or at least 1 weight % and up to and including 90 weight % or up to and including 25 weight %, as long as the photocurable composition does not become too viscous that it cannot be readily printed using a relief printing member.

Useful film-forming non-photocurable resins include but are not limited to, one or more of a poly(methyl methacrylate) (PMMA), poly(methyl acrylate), poly(butyl methacrylate), polyvinyl butyral, polyvinyl acetate, polystyrene, polyethylene terephthalate, polybutylene terephthalate, polyhydroxyalkanoate, polyhydroxybutyrate, polybutylene succinate, and polyamide. A poly(methyl methacrylate) is particularly useful.

Evaluation of useful photoinitiator compositions as initiating systems for photopolymerization or photocuring can be carried out using an acrylate-based coating formulation. Irradiation to initiate photocuring can be carried out using a filtered mercury lamp output through a band-pass filter. This is just one source of useful radiation. The efficiency of photopolymerization can be determined by the amount of photocrossliked polymer retained after solvent removal and printing.

### Relief Printing Members

The relief printing members useful in the practice of this invention can be comprised of one or more elastomeric layers, with or without a substrate, in which a relief image can be generated using suitable imaging means. For example, the relief layer comprising a relief pattern can be disposed on a suitable substrate.

For example, the relief printing member (for example, flexographic printing member) having a relief layer comprising an uppermost relief surface and an average relief image depth (pattern height) of at least 50 μm, or typically having an average relief image depth of at least 100 μm relative from the uppermost relief surface, can be prepared from imagewise exposure of an elastomeric photopolymerizable layer in an relief printing member precursor such as a flexographic printing member precursor, for example as described in U.S. Pat. No. 7,799,504 (Zwadlo et al.) and U.S. Pat. No. 8,142,987 (Ali et al.) and U.S. Patent Application Publication 2012/0237871 (Zwadlo), the disclosures of which are incorporated herein by reference for details of such precursors. Such elastomeric photopolymerizable layers can be imaged through a suitable mask image to provide an elastomeric relief element (for example, flexographic printing plate or flexographic printing sleeve). In some embodiments, the relief layer comprising the relief pattern can be disposed on a suitable substrate as described in the noted Ali et al. patent. Other useful materials and image formation methods (including development) for provide elastomeric relief images are also described in the noted Mi et al. patent.

In other embodiments, the relief printing member can be provided from a direct (or ablation) laser-engraveable relief printing member precursor, with or without integral masks, as described for example in U.S. Pat. No. 5,719,009 (Fan), U.S. Pat. No. 5,798,202 (Cushner et al.), U.S. Pat. No. 5,804,353 (Cushner et al.), U.S. Pat. No. 6,090,529 (Gelbart), U.S. Pat. No. 6,159,659 (Gelbart), U.S. Pat. No. 6,511,784 (Hiller et al.), U.S. Pat. No. 7,811,744 (Figov), U.S. Pat. No. 7,947,426 (Figov et al.), U.S. Pat. No. 8,114,572 (Landry-Coltrain et al.), U.S. Pat. No. 8,153,347 (Veres et al.), U.S. Pat. No. 8,187,793 (Regan et al.), and U.S. Patent Application Publications 2002/0136969 (Hiller et al.), 2003/0129530 (Leinenback et al.), 2003/0136285 (Telser et al.), 2003/0180636 (Kanga et al.), and 2012/0240802 (Landry-Coltrain et al.).

As noted above, average relief image depth (relief pattern) or an average relief pattern height in the relief pattern is at least 50 μm or typically at least 100 μm relative to the uppermost relief surface. A maximum relief image depth (relief pattern) or relief pattern height can be as great as 1,000 μm, or typically up to and including 750 μm, relative to the uppermost relief surface.

### Methods for Providing Photocured Patterns

The method of this invention includes the provision of an relief printing member as described above to print a suitable pattern of the photocurable composition described herein. The present invention enables printing of a variety of photocurable compositions over relatively large areas with desirable resolution (for example, a line width of less than 20 μm or even less than 15 μm). In some embodiments, the resolution (line width) can be as low as 5 μm or even as low as 1 μm. The method also provides a means for printing of sequential overlying patterns without hindering the utility of one or more underlying layers. The method can be adapted to high-speed production processes for the fabrication of electronic devices and components.

The photocurable composition can applied in a suitable manner to the uppermost relief surface (raised surface) in the elastomeric relief element. Application of the photocurable composition can be accomplished using several suitable means. Thus, it is desirable that as much as possible of the photocurable composition is applied predominantly to the uppermost relief surface. Anilox roller systems or other roller application systems, especially low volume Anilox rollers, below 2.5 billion cubic micrometers per square inch (6.35 billion cubic micrometers per square centimeter) and associated skive knives are used in flexographic printing presses are particularly advantageous for this application of the photocurable composition. Optimum metering of the printable material composition onto the uppermost relief surface only can be achieved by controlling the photocurable composition viscosity or thickness, or choosing an appropriate application means.

The photocurable composition can have a viscosity during this application of at least 1 cps (centipoise) and up to and including 1000 cps.

The photocurable composition can be applied at any time after the relief image is formed within a relief printing member. The photocurable composition can be applied by any suitable means, including the use of an Anilox roller system, which can be one of the most useful ways for application to the uppermost relief surface. The thickness of the photocurable composition on the relief image is generally limited to a sufficient amount that can readily be transferred to a substrate but not too much to flow over the edges of the relief element in the recesses when the photocurable composition is applied to the relief printing member.

A substrate is provided on which a desired pattern of a photocurable composition is formed using a relief printing member. This substrate can be composed of any suitable material including but are not limited to, polymeric films, metals, silicon or ceramics, fabrics, papers, and combinations thereof (such as laminates of various films, or laminates of papers and films) provided that a pattern of a photocurable composition can be formed on at least one receptive surface thereof. The substrate can be transparent or opaque, and rigid or flexible. The substrate can include one or more polymeric or non-polymeric layers or one or more patterns of other materials before the pattern of photocurable composition is applied according to the present invention. A surface of the substrate can be treated for example with a primer layer or electrical or mechanical treatments (such as graining) to render that surface a “receptive surface” to achieve suitable adhesion of the photocurable composition.

In some embodiments, the substrate comprises a separate receptive layer as the receptive surface disposed on a substrate, which receptive layer and substrate can be composed of a material such as a suitable polymeric material that is highly receptive of the photocurable composition. In particular, the receptive layer can be chosen from the materials described above that are receptive to the photocurable composition that forms the desired pattern on the substrate with high resolution. The receptive layer generally has a dry thickness of at least 0.05 μm and up to and including 10 μm, or typically of at least 0.05 μm and up to and including 3 μm, when measured at 25° C.

A surface of the substrates can be treated by exposure to corona discharge, mechanical abrasion, flame treatments, or oxygen plasmas, or by coating with various polymeric films, such as poly(vinylidene chloride) or an aromatic polysiloxane as described for example in U.S. Pat. No. 5,492,730 (Balaba et al.) and U.S. Pat. No. 5,527,562 (Balaba et al.) and U.S. Patent Application Publication 2009/0076217 (Gommans et al.), to make that surface more receptive to the photocurable composition.

Suitable substrates materials include but are not limited to, metallic films or foils, metallic films on polymer, glass, or ceramic supports, metallic films on electrically conductive film supports, semi-conducting organic or inorganic films, organic or inorganic dielectric films, or laminates of two or more layers of such materials. For example, useful substrates can include indium-tin oxide coated glass, indium-tin oxide coated polymeric films, poly(ethylene terephthalate) films, poly(ethylene naphthalate) films, polyimide films, polycarbonate films, polyacrylate films, polystyrene films, polyolefin films, polyamide films, silicon, metal foils, cellulosic papers or resin-coated or glass-coated papers, glass or glass-containing composites, ceramics, metals such as aluminum, tin, and copper, and metalized films. The substrate can also include one or more charge injection layers, charge transporting layers, and semi-conducting layers on which the photocurable composition pattern is formed.

Particularly useful substrates are polyesters films such as poly(ethylene terephthalate), polycarbonate, or poly(vinylidene chloride) films that have been surface-treated as noted above, or coated with one or more suitable adhesive or subbing layers, the outer layer being receptive to the photocurable composition. A useful outer layer can be a vinylidene chloride polymer containing layer.

Useful substrates can have a desired dry thickness depending upon its eventual use, for example its incorporation into various articles or devices (for example optical devices, optical panels, or touch screens). For example, the dry thickness can be at least 0.001 mm and up to and including 10 mm, and especially for polymeric films, the dry thickness can be at least 0.008 mm and up to and including 0.2 mm.

A transfer pressure can be applied to either the relief printing member or the substrate to assure contact and complete transfer of the photocurable composition to the substrate. For example, transfer of the photocurable composition can be carried out by moving the uppermost relief surface of the relief printing member relative to the substrate, by moving the substrate relative to the uppermost relief surface of the relief printing member, or by relative movement of both elements to each other. In some embodiments, the photocurable composition is transferred to the substrate manually. In other embodiments, the transfer is automated such as by example, by a conveyor belt, reel-to-reel process, directly driven moving fixtures, chain, belt, or gear-driven fixtures, frictional roller, printing press, or rotary apparatus, or any combination of these methods.

The substrate and relief printing member can be kept in contact for as little as 10 milliseconds or up to 10 seconds or as much as 60 seconds or more. Once the desired contact is completed, the relief printing member is separated from the substrate to leave a desired pattern of the photocurable composition on the substrate. At least 70 weight % of the photocurable composition that was originally disposed on the uppermost relief surface of the relief printing member (using one or more applications of photocurable composition) is transferred to the substrate in a desired pattern.

Separation of the relief printing member and the substrate can be accomplished using any suitable means including but not limited to, manual peeling apart, impingement of gas jets or liquid jets, or mechanical peeling devices.

In general, transferring the photocurable composition from the raised uppermost relief surface of the relief printing member to the substrate creates a pattern of the photocurable composition on the substrate to be cured as described below. The transferring can be referred to as “printing” (or lamination or embossing). The pattern of the photocurable composition on the substrate can comprise lines, solid areas, dots, or a mixture of lines and solid areas in any desired pattern that text, numbers, shapes, or other images, or combinations thereof. In general, the average line width for printed lines in a pattern on the substrate can be less than 20 μm or even less than 15 μm and as wide as 2 μm. Such lines can also have an average height of at least 10 nm and up to and including 4,000 μm. These average dimensions can be determined by measuring the lines in at least 10 different places and determining the width or height using known image analysis tools including but not limited to, profilometry, optical microscopic techniques, atomic force microscopy, and scanning electron microscopy.

While a particularly useful method of applying the photocurable composition to the substrate include the use of flexography and the relief printing member is a flexographic printing member comprising a relief image, the photocurable composition can also be applied to a substrate using alternative appropriate printing methods (intaglio or gravure printing) that would be readily apparent to one skilled in the art using the teaching provided herein.

In some of the embodiments, the method of this invention provides a printed pattern of fine lines of a photocurable composition that, after curing, can contain a seed material for a subsequent electroless plating process. For example, for copper electroless plating, such seed materials include but are not limited to, metals such as palladium, tin, nickel, platinum, iridium, rhodium, and silver, or a mixture of tin and palladium.

### Method of Using Photocurable Compositions

Once the photocurable composition described herein has been applied to a suitable substrate in a patternwise fashion to form a pattern of the photocurable composition on the substrate, the pattern of the photocurable composition is exposed to suitable photocuring radiation to form a photocured pattern on the substrate.

Thus, once the photocurable composition has been “printed”, the resulting pattern is exposed in the presence of oxygen, or it can be carried out in an inert (for example, nitrogen or argon) environment. In general, the exposing can be carried out using radiation having a wavelength of at least 150 nm or typically at least 300 nm and up to and including 1250 nm. More typically, the irradiation is at a wavelength of at least 150 nm and up to and including 750 nm. A mixture of exposure wavelengths can be used during the photocuring process.

The following Examples provide an illustration of the use of the photocurable composition.

### Example 1

Amplified quantum yield of 2-chlorothioxanthone (S-2) photosensitized reaction of N-methoxy-4-phenylpyridinium hexafluorophosphate (OZ-1) and triethylphosphite in acetonitrile-d₃:

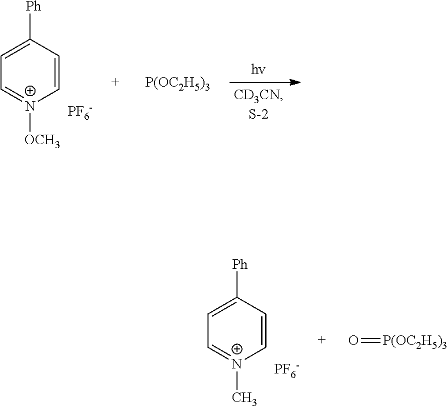

The 2-chlorothioxanthone (S-2) (0.002 moles) sensitizer was added to a 3 ml solution of 0.02 molar N-methoxy-4-phenylpyridinium hexafluorophosphate (OZ-1) and 0.02 M triethylphosphite in acetonitrile-d₃. In a 1×1 cm quartz cell, this solution was purged with a thin stream of argon for 2-3 minutes and then irradiated at 405 nm for 30 seconds. Argon or nitrogen was continuously passed through the reaction mixture during photolysis to purge as well as stir the solution. After photolysis, ¹H NMR spectrum of the photolysate was recorded and the percent conversion of the starting materials was determined by integration of diagnostic signals. Before photolysis, the ¹H NMR spectrum of an solution of OZ-1, triethylphosphite and a catalytic amount of 2-chlorothioxanthone in acetonitrile-d₃ shows characteristic signals due to the N-methoxypyridinium salt (δ: 8.94 (m, 2H), 8.35 (m, 2H), 7.94 (m, 2H), 7.69 (m, 3H), and 4.43 (s, 3H)), triethylphosphite (δ: 3.84 (quintet, 6H), 1.23 (t, 9H)). After irradiation at 405 nm for about 30 seconds, the ¹H NMR spectrum of the photolysate clearly showed appearance of new diagnostic signals due to formation of 4-phenylpyridine (δ: 8.71 (m, 2H) and 8.26 (m, 2H) and triethylphosphite (δ: 4.06 (quintet, 6H) and 1.30 (t, 9H)), N-methyl-4-phenylpyridinium (δ: 4.30 (s, 3 H)). The identity of these products was established by comparison with ¹H NMR spectra of authentic samples. The yields of the photoproducts were determined from quantitative integration of ¹H NMR spectra of the reaction mixtures containing products N-methyl-4-phenylpyridinium signal at δ: 4.30 relative to starting material N-methoxy signal of OZ-1 at δ: 4.43, as well as signals due to product triethylphosphate at δ: 4.06 relative to starting material triethylphosphite at δ: 3.84. Conversions were kept between 15-20% to minimize any secondary photolysis of the products. The photon flux at the excitation wavelengths, 405 nm, was determined by using the known photocycloaddition reaction of phenanthrenequinone to trans-stilbene in benzene as an actinometer (Bohning, J. J.; Weiss, K. J. Am. Chem. Soc. 1966, 88, 2893.). The light intensity was within 7-10×10⁻⁸ Einsteins min⁻¹. The quantum yield of reaction was determined by dividing the moles of photoproducts formed by total light intensity and is shown below in TABLE IV.

### Example 2

Amplified quantum yield of 2-chlorothioxanthone (S-2) photosensitized reaction of N-methoxy-4-phenylpyridinium hexafluorophosphate (OZ-1) and triethylphosphite in acetonitrile-d₃:

This example shows effect of the concentration of the N-oxyazinium salt OZ-1 on the quantum yield. The 2-chlorothioxanthone (S-2) (0.002 moles) sensitizer was added to a 3 ml solution of 0.04 molar N-methoxy-4-phenylpyridinium hexafluorophosphate (OZ-1) and 0.02 molar triethylphosphite in acetonitrile-d₃. In a 1×1 cm quartz cell, this solution was purged with a thin stream of argon for 2-3 minutes and was then irradiated at 405 nm for 10-30 seconds minutes. Argon or nitrogen was continuously passed through the reaction mixture during photolysis to purge as well as stir the solution. After photolysis, ¹H NMR spectrum of the photolysate was recorded and the percent conversion of the starting materials was determined by integration of diagnostic signals as described above. The quantum yield of reaction was determined by dividing the moles of photoproducts formed by total light intensity and is shown below in TABLE IV.

TABLE IV
Reaction of Triplet Sensitized Reaction of N-Oxyazinium
Salts with and without Phosphite: Effect of Concentration
of N-Oxyazinium on Quantum Yields.

| | | Amount of | Quantum |
|---|---|---|---|
| | | Triethylphosphite | Yield |
| Comparative 1 | 0.002 molar S-2 + | 0 | 0.95 |
| | 0.02 molar OZ-1 | | |
| Example 1 | 0.002 molar S-2 + | 0.02 molar | 30.0 |
| | 0.02 molar OZ-1 | | |
| Example 2 | 0.002 molar S-2 + | 0.02 molar | 70.0 |
| | 0.04 molar OZ-1 | | |

The data in TABLE IV clearly show that the quantum yields of reaction of N-oxyazinium salt OZ-1, by photoinduced electron transfer from S-2, are greatly amplified in the presence of the added triethylphosphite relative to Comparative 1 when no triethylphosphite was added.

The unexpected curing speed produced by the photoinitiator compositions of the present invention is best understood by comparing their performance, when used with an efficiency amplifier phosphite, to their performance when used without one. A series of photocurable polymerizable mixtures containing invention photoinitiator compositions were formulated and compared with photocurable mixtures containing only N-oxyazinium salt and photosensitizer. Photocurable polymerizable mixtures were formulated as described below in Comparative 2 and Example 3.

The following Examples demonstrate the cure efficiency of photoinitiator composition in air.

### Comparative 2:

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (14.2 mg, 5.7×10⁻⁵ moles), and 4-phenyl-N-methoxypyridinium hexafluorophosphate N-oxyazinium salt OZ-1 (40.5 mg, 1.2×10⁻⁴ moles) were added and dissolved at room temperature. Each formulation was then coated onto a glass plate and exposed to 405 nm radiation in air. After this irradiation, the samples were washed with acetone and the cure efficiency was measured in terms of the amount of crosslinked polymer left. The results are summarized in TABLE V below.

### Example 3

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (12.2 mg, 5.7×10⁻⁵ moles), and 4-phenyl-N-methoxypyridinium hexafluorophosphate N-oxyazinium salt OZ-1 (40.5 mg, 1.2×10⁻⁴ moles) were added and dissolved at room temperature. The mixture was split in two equal parts and in a second part, triethylphosphite efficiency amplifier (63 mg, 7.7×10⁻⁴ moles) was added. The formulation was then coated onto a glass plate and exposed to 405 nm radiation in air. After irradiation, the sample was washed with acetone and the cure efficiency measured in terms of the amount of crosslinked polymer left. The results are summarized below in TABLE V.

TABLE V
Effect of Efficiency Phosphite on Photocuring in Air

| | | Material left after |
|---|---|---|
| | Degree of Curing | Solvent Wash? |
| Comparative 2 | No | No |
| Example 3 | Extensive curing | Yes |

These results clearly show that in the presence of the efficiency amplifier phosphite, photocuring of the polymerizable composition was quite extensive relative to Comparative 2.

The following Comparative 3 and Example 4 compare the photocuring speed of a photoinitiator composition containing an efficiency amplifier phosphate with a composition containing no efficiency amplifier.

### Comparative 3:

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (12.2 mg, 5.7×10⁻⁵ moles), and 4-phenyl-N-methoxypyridinium hexafluorophosphate N-oxyazinium salt OZ-1 (40.5 mg, 1.2×10⁻⁴ moles) were added and dissolved at room temperature. The formulation was then coated onto a glass plate and exposed to 405 nm radiation under N₂. After irradiation, the sample was washed with acetone and cure efficiency measured in terms of the amount of crosslinked polymer left. The results are summarized in TABLE VI.

### Example 4

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (12.2 mg, 5.7×10 moles), and 4-phenyl-N-methoxypyridinium hexafluorophosphate N-oxyazinium salt OZ-1 (40.5 mg, 1.2×10⁻⁴ moles) were added and dissolved at room temperature and triethylphosphite efficiency amplifier (500 mg, 0.30 moles) was added to the formulation. The formulation was then coated onto a glass plate and exposed to 405 nm radiation under N₂. After irradiation, the sample was washed with acetone and the cure efficiency was measured in terms of the amount of crosslinked polymer left. The results are summarized below in TABLE VI.

TABLE VI
Effect of Efficiency Amplifier Triethylphosphite on Cure Speed

| | Dose Required for Complete |
|---|---|
| Photoinitiator Composition | Photocuring |
| Comparative 3 | 90 mJ/cm² |
| OZ-1 + S-2 | |
| Example 4 | 5 mJ/cm² |
| OZ-1 + S-2 + Triethylphosphite | |

These results clearly show that in the use of the efficiency amplifier provided quite rapid photocuring of the polymerizable composition (by a factor of 18) relative to the photoinitiator composition used in Comparative 3.

### Comparative 4:

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (14.2 mg, 5.7×10⁻⁵ moles), and 3-phenyl-N-methoxypyridinium tetrafluoroborate N-oxyazinium salt OZ-2 (33 mg, 1.2×10⁻⁴ moles) were added and dissolved at room temperature. The formulation was then coated onto a glass plate and exposed to 405 nm radiation in air. After exposure, the sample was washed with acetone and the cure efficiency was measured in terms of the amount of crosslinked polymer left. The results are summarized below in TABLE VII.

### Example 5

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (14.2 mg, 5.7×10⁻⁵ moles), and 3-phenyl-N-methoxypyridinium tetrafluoroborate N-oxyazinium salt OZ-2 (33 mg, 1.2×10⁻⁴ moles) were added and dissolved at room temperature. The mixture was split into two equal parts and in second part the triisopropylphosphite efficiency amplifier (79 mg, 7.5×10⁻⁴ moles) was added. The formulation was then coated onto a glass plate and exposed to 405 nm radiation in air. After irradiation, the sample was washed with acetone and the cure efficiency was measured in terms of the amount of crosslinked polymer left. The results are summarized below in TABLE VII.

TABLE VII
Effect of Efficiency Amplifier Phosphite on Photocuring in Air

| Photoinitiator | | Material left after |
|---|---|---|
| Composition | Extent of Curing | Solvent Wash? |
| Comparative 4 | No | No |
| OZ-2 + S-2 | | |
| Example 5 | | |
| OZ-2 + S-2 + | Extensive | Yes |
| Triisopropylphosphite | | |

These results also show the considerable improvement in photocuring in air when the photoinitiator composition was used compared to the Comparative 4 composition that did not contain an efficiency amplifier for the N-oxyazinium salt.

### Comparative 5:

To a mixture of multifunctional acrylates (10 g, 8:2 by weight mixture of polyethylene glycol 200 diacrylate (SR259) and dipentaerythritol pentaacrylate ester (SR399) (both from Sartomer), ketocoumarin photosensitizer S-9 (12.2 mg, 3×10⁻⁵ moles), and 4-phenyl-N-methoxypyridinium hexafluorophosphate N-oxyazinium salt OZ-1 (40.5 mg, 1.2×10⁻³ moles) were added and dissolved at room temperature. The formulation was then coated onto a glass plate and exposed to 365 nm radiation in air. After irradiation, the sample was washed with acetone and the cure efficiency was measured in terms of the amount of crosslinked polymer left. The results are summarized below in TABLE VIII.

### Example 6

To a mixture of multifunctional acrylates (10 g, 8:2 by weight mixture of polyethylene glycol 200 diacrylate (SR259) and dipentaerythritol pentaacrylate ester (SR399) (both from Sartomer), ketocoumarin photosensitizer S-9 (12.2 mg, 3×10⁻⁵ moles), and 4-phenyl-N-methoxypyridinium hexafluorophosphate N-oxyazinium salt OZ-1 (40.5 mg, 1.2×10⁻³ moles) were added and dissolved at room temperature. The mixture was split into two equal parts and in the second part, the triethylphosphite efficiency amplifier (63 mg, 8×10⁻⁴ moles) was added. The formulation was then coated onto a glass plate and exposed to 365 nm radiation in air. After irradiation, the sample was washed with acetone and the cure efficiency measured in terms of the amount of crosslinked polymer left. The results are summarized below in TABLE VIII.

TABLE VIII
Effect of Efficiency Amplifier Phosphite on Photocuring in Air.

| | | Material left after |
|---|---|---|
| | Degree of Curing | Solvent Wash? |
| Comparative 5 | No | No |
| OZ-1 + S-9 | | |
| Example 6 | Extensive curing | Yes |
| OZ-1 + S-9 + | | |
| Triethylphosphite | | |

These results clearly show that in the presence of the efficiency amplifier improves photocuring of the polymerizable composition quite extensively relative to the composition used in Comparative 5.

### Example 7

A mixture of multifunctional acrylates [10 g, 8:2 by weight mixture of polyethylene glycol 200 diacrylate (SR259) and dipentaerythritol pentaacrylate ester (SR399) (both from Sartomer)], 2-chlorothioxanthone photosensitizer S-2 (12.2 mg, 5.7×10⁻⁵ moles), 4-phenyl-N-methoxypyridinium hexafluorophosphate N-oxyazinium salt OZ-1 (50.5 mg, 1.4×10⁻⁴ moles), and triisopropylphosphite efficiency amplifier (200 mg, 7.3×10⁻³ moles) were added in anisole (0.5 ml) and dissolved at room temperature.

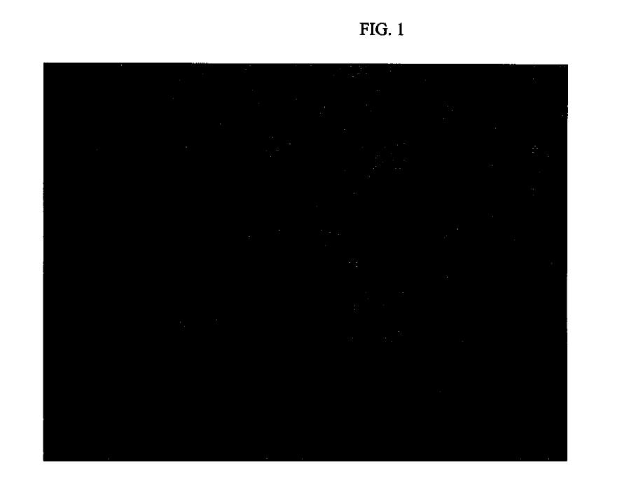

The resulting photocurable composition was flexographically printed (IGT Printability Tester F1) onto a polyethylene terephthalate film as a substrate using a flexographic printing plate (relief printing member) having a relief image. The printed pattern of photocurable composition was then cured in UV light using a Fusion UV MC6R benchtop conveyor (effective UV dose ˜80 mJ/cm²). FIG. 1 shows the resulting flexographically printed and UV-photocured pattern (image) as determined using Nomarski differential interference contrast (DIC) microscopy.

The invention has been described in detail with particular reference to certain preferred embodiments thereof, but it will be understood that variations and modifications can be effected within the spirit and scope of the invention.

1. A method for providing a photocured pattern, comprising:
applying a photocurable composition to a substrate in a patternwise fashion using a relief printing member to form a pattern of the photocurable composition, and
exposing the pattern of the photocurable composition to photocuring radiation to form a photocured pattern on the substrate,
wherein the photocurable composition comprising an N-oxyazinium salt photoinitiator, a photosensitizer for the N-oxyazinium salt, an N-oxyazinium salt efficiency amplifier, and one or more photocurable acrylates.

2. The method of claim 1, wherein the relief printing member is a flexographic printing member.

3. The method of claim 1, wherein the photocurable composition further comprises an inert organic solvent.

4. The method of claim 1, wherein at least one of the one or more acrylates is a solvent for the photocurable composition.

5. The method of claim 1, wherein the exposing is carried out in the presence of oxygen.

6. The method of claim 1, wherein the exposing is carried out using radiation having a wavelength of at least 300 nm and up to and including 1250 nm.

7. The method of claim 1, wherein the photocurable composition comprises at least one photocurable acrylate acting as the solvent.

8. The method of claim 1 wherein the N-oxyazinium salt efficiency amplifier is an organic phosphite.

9. The method of claim 1 wherein the N-oxyazinium salt efficiency amplifier is an organic phosphite having the formula:
(R′O)₃P
wherein the multiple R′ groups are the same or different alkyl groups wherein the multiple R groups are the same or different hydrogen atoms or alkyl groups, or two R′ groups can form a cyclic aliphatic ring or fused ring system, x is a number at least 2 and up to and including 20, and y is at least 1 and up to and including 20.

10. The method of claim 1, wherein the N-oxyazinium salt efficiency amplifier is a phosphite that is present in the photocurable composition at a molar ratio to the N-oxyazinium salt photoinitiator is at least 0.001:1 and up to and including 10:1.

11. The method of claim 1, wherein the N-oxyazinium salt photoinitiator is represented by either of the following Structures (I) and (II): 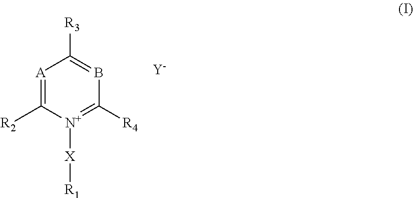
wherein A and B in Structure (I) independently represent a carbon, C—R₅, C—R₆ or nitrogen, X is O, R₁, R₂, R₃, R₄, R₅, and R₆ are independently hydrogen, or alkyl or aryl groups, any of the A, B, and R groups where chemically feasible can be joined to form a ring, and Y is a charge balancing anion that can be a separate moiety or part of an A, B, or R, 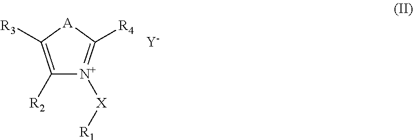
wherein A in Structure (II) represents a carbon, C—R₅, nitrogen, sulfur or oxygen atom with sufficient bonds and substituents to form a heteroaromatic ring, X is O, R₁, R₂, R₃, R₁, and R₅ are independently hydrogen, or alkyl or aryl groups, or any two R groups may form a ring, and Y is a charge balancing anion that can be a separate moiety or part of an R group.

12. The method of claim 1, wherein the N-oxyazinium salt photoinitiator has a cation represented by one of the following formulae: 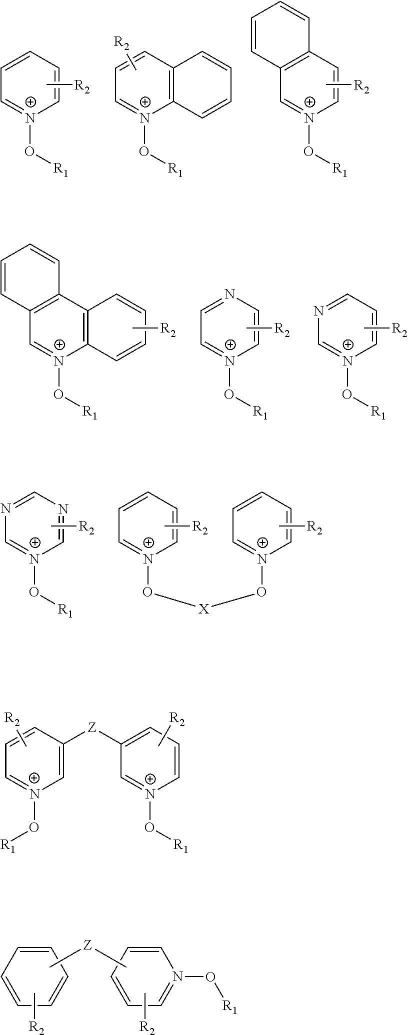
wherein R₁ represents a substituted or unsubstituted alkyl group, substituted or unsubstituted aryl group, or an acyl group, wherein R₁ can also include a charge balancing anion, the R₂ groups independently represent hydrogen, or a substituted or unsubstituted alkyl, aryl, or heteroaryl group, X is a divalent linking group, and Z is an alkylidene group.

13. The method of claim 1, wherein the N-oxyazinium salt photoinitiator has a reduction potential less negative than −1.4 V and comprises an N-oxy group that is capable of releasing an oxy radical during irradiation of the photocurable composition.

14. The method of claim 1, wherein the photocurable composition comprises the N-oxyazinium salt photoinitiator in an amount of at least 6×10⁻⁷ and up to and including 6×10⁻² moles per gram of one or more photocurable acrylates.

15. The method of claim 1, wherein the photosensitizer is present in the photocurable composition in an amount of at least 5×10⁻⁷ and up to and including 1×10⁻⁴ moles per gram of one or more photocurable acrylates.

16. The method of claim 1, wherein the photosensitizer for the N-oxyazinium salt photoinitiator has a triplet energy of at least 20 kcal/mole of N-oxyazinium salt.

17. The method of claim 1, wherein the one or more photocurable acrylates comprises an acrylate that comprises the photosensitizer for the N-oxyazinium salt photoinitiator.
